(19) United States
(12) Patent Application Publication
(10) Pub. No.: US 2008/0194345 A1
(43) Pub. Date: Aug. 14, 2008

(54) Device for Compensating for Torque in Motor

(76) Inventor: Hyeung Sik Choi, Busan (KR)

Correspondence Address: BIRCH STEWART KOLASCH & BIRCH, PO BOX 747, FALLS CHURCH, VA, 22040-0747, US

(21) Appl. No.: 11/997,542

(22) PCT Filed: Apr. 19, 2007
(86) PCT No.: PCT/KR2007/001918

§ 371 Date: Jan. 31, 2008

(30) Foreign Application Priority Data
May 4, 2006 (KR) 10-2005-0040308
Mar. 23, 2007 (KR) 10-2007-0028445

(51) Int. Cl. H02K 7/02; F16C 3/00

(52) U.S. Cl. 464/180

(57) ABSTRACT

Disclosed is a device for compensating for torque in a motor, which includes a stationary plate through the center of which a rotational shaft of the motor passes, and that is fixed to a support independent of rotational motion of the motor; a rotary plate that comes into close contact with the stationary plate, and that is rotatably coupled to the rotational shaft of the motor at the center thereof; and an elastic mechanism that has at least one slot formed along the circumference of any one selected from one surface of the stationary plate and one surface of the rotary plate, at least one elastic blade formed on the slot-free opposed surface and inserted into the slot, and at least one spring inserted into the slot and applying an elastic force in a circumferential direction in contact with the elastic blade.

### TECHNICAL FIELD

The present invention relates to a device for compensating for torque in a motor, which comprises a stationary plate through the center of which a rotational shaft of the motor passes, and that is fixed to a support independent of the rotational motion of the motor; a rotary plate that comes into close contact with the stationary plate, and that is rotatably coupled to the rotational shaft of the motor at the center thereof; and an elastic mechanism that has at least one slot formed along the circumference of one selected from one surface of the stationary plate and one surface of the rotary plate, at least one elastic blade formed on the slot-free opposed surface and inserted into the slot, and at least one spring inserted into the slot and applying an elastic force in a circumferential direction in contact with the elastic blade, so that, when a load coupled to the rotary plate is subjected to gravitational torque depending on the rotational angle thereof due to gravity, the gravitational torque is compensated for by the circumferential elastic force generated from the elastic mechanism.

### BACKGROUND ART

In general, when a force is applied to a link (or a load) connected to the rotational shaft of a driving motor in a robot or automatic machine, the torque of the load (hereinafter, referred to as “gravitational torque”) increases with the angle of rotation due to the influence of gravity.

More specifically, as a working object or a robot arm rotates, the rotational angle thereof is increased, thus increasing the moment of force due to gravity. This moment is generated from the driving motor in proportion to the increase in the rotational angle. In order to counteract or overcome this moment, additional output of the driving motor for overcoming the moment must be applied to the rotational force of the load.

Typically, the motor has weak driving torque in spite of a high rpm. Thus, in order to overcome the moment generated by the gravitational torque, the motor is increased in size, or reduction gearing is added thereto. This technical solution has drawbacks in that the volume and weight of the driving motor are greatly increased, and thus, in the case in which the driving motor is mounted to a machine such as a robot, the machine cannot be manufactured as a compact lightweight machine, and in that much of the output of the driving motor is wasted.

To overcome these drawbacks, the related technical method improves torque performance by directly coupling a planetary gear type harmonic drive or rotary vector (RV) reducer to the shaft of the driving motor in order to reduce the volume and weight of a speed reducer. In comparison with an ordinary speed reducer, the harmonic drive or the RV reducer is relatively small and lightweight. However, in comparison with the driving motor, the harmonic drive or the RV reducer is still big, and is restricted in the torque performance to a predetermined reduction ratio or higher.

### DISCLOSURE

### Technical Problem

Accordingly, the present invention has been made in an effort to solve the problems occurring in the related art, and an object of the present invention is to provide a device for compensating for torque in a motor, which automatically compensates for the moment of a load which is generated by gravitational torque according to the rotational angle.

Another object of the present invention is to provide a device for compensating for torque in a motor, which compensates for the torque without varying the size of the motor or using reduction gearing, unlike the related method of compensating for the torque, thereby making an entire machine, such as a robot, compact and lightweight when the device is mounted on such a machine, and reducing the waste of output of the motor.

### Technical Solution

In order to achieve the above object, according to an aspect of the present invention, there is provided a device for compensating for torque in a motor, which comprises a stationary plate through the center of which a rotational shaft of the motor passes, and that is fixed to a support independent of the rotational motion of the motor; a rotary plate that comes into close contact with the stationary plate, and that is rotatably coupled to the rotational shaft of the motor at the center thereof; and an elastic mechanism that has at least one slot formed along the circumference of any one selected from one surface of the stationary plate and one surface of the rotary plate, at least one elastic blade formed on the slot-free opposite surface and inserted into the slot, and at least one spring inserted into the slot and applying elastic force in a circumferential direction in contact with the elastic blade. When a load coupled to the rotary plate is subjected to gravitational torque depending on the rotational angle thereof due to gravity, the gravitational torque is compensated for by the circumferential elastic force generated from the elastic mechanism.

According to another aspect of the present invention, the elastic mechanism has one spring per slot, and the spring is inserted between the inner wall of one end of the slot and the elastic blade such that one end thereof serves as a fixed end and the other end thereof serves as a free end, so that the device compensates for the gravitational torque caused by unidirectional rotation.

According to another aspect of the present invention, the elastic mechanism has two springs per slot, and the two springs are inserted between the slot and the elastic blade on the opposite sides of the elastic blade such that one end of each thereof serves as a fixed end and the other end of each thereof serves as a free end, so that the device compensates for the gravitational torque caused by bidirectional rotation.

According to another aspect of the present invention, the elastic mechanism is a parallel elastic mechanism having a concentric arcuate shape in which at least one slot can be formed in an arcuate shape in any one selected from one surface of the rotary plate and one surface of the stationary plate on each of at least two concentric circles having different diameters, and at least one elastic blade is formed on the other opposite surface and fitted into the slot.

### ADVANTAGEOUS EFFECTS

According to the present invention, the device for compensating for torque in a motor has an advantage in that it automatically compensates for the moment of a load which is generated by the gravitational torque according to the rotational angle.

Further, the device for compensating for torque in a motor has an advantage in that it compensates for the torque without varying the size of the motor or using reduction gearing, unlike the related method of compensating for the torque, thereby making an entire machine, such as a robot, compact and lightweight when the device is mounted on such a machine, and reducing the waste of output of the motor.

In addition, the device for compensating for torque in a motor has an advantage in that it has an additional function of relieving impact on the driving motor or speed reducer when excessive external force or impact is applied to the motor.

### DESCRIPTION OF DRAWINGS

FIG. 1 is a perspective view illustrating a stationary plate in a device for compensating for torque in a motor according to an embodiment of the present invention;

FIG. 2 is a perspective view illustrating a rotary plate in a device for compensating for torque in a motor according to an embodiment of the present invention;

FIG. 3 is a side view illustrating a machine on which a device for compensating for torque in a motor according to an embodiment of the present invention is mounted;

FIGS. 4 through 6 are plan views illustrating the operation of a device for compensating for torque in a motor according to an embodiment of the present invention; and

FIG. 7 is a plan view illustrating a device for compensating for torque in a motor according to another embodiment of the present invention, wherein the device includes a parallel elastic mechanism.

<Description of symbols of the main parts in the drawings>

| | | | |
|---|---|---|---|
| 10: | stationary plate | 20: | rotary plate |
| 30: | elastic mechanism | 31: | spring |
| 32: | slot | 33: | elastic blade |
| 100: | motor | 110: | speed reducer |

### BEST MODEL

Reference will now be made in greater detail to an exemplary embodiment of the invention with reference to the accompanying drawings. In the description of the invention, when the detailed descriptions of known functions and constructions are determined to make the subject matter of the invention unnecessarily obscure, they will be avoided hereinafter.

Further, technical terms, as will be described below, are defined in consideration of their functions in the invention, and thus may vary according to the intention of the user or operator, or according to usual practice. Therefore, it is apparent that such terms should be defined based on the contents of this specification.

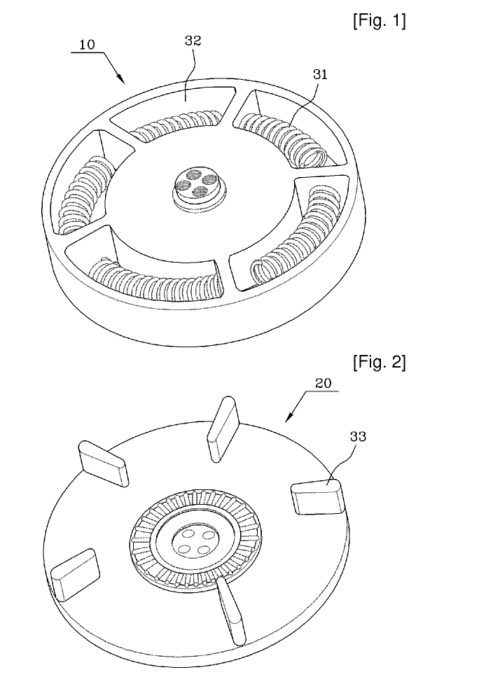

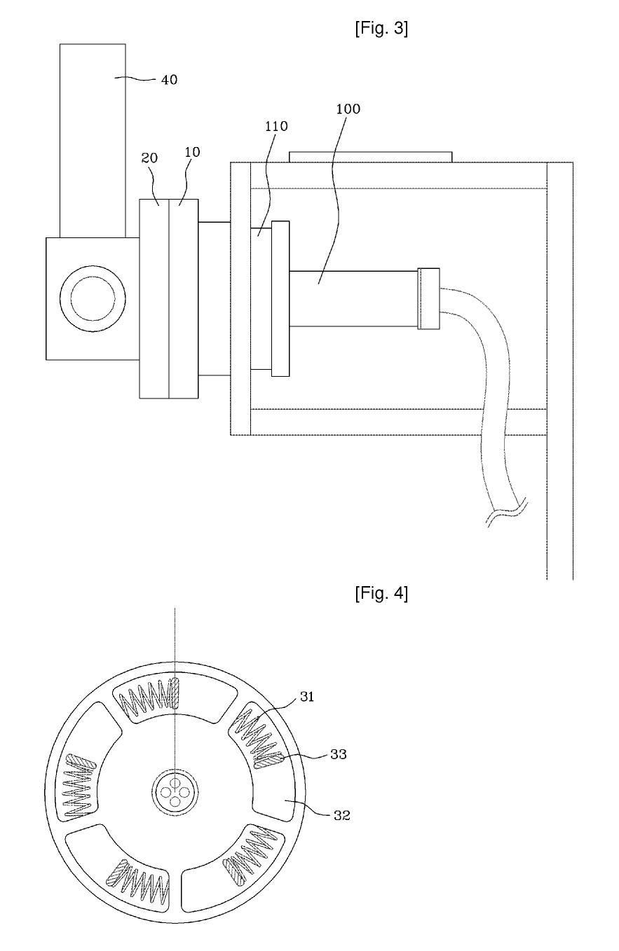

FIG. 1 is a perspective view illustrating a stationary plate in a device for compensating for torque in a motor according to an embodiment of the present invention. FIG. 2 is a perspective view illustrating a rotary plate in a device for compensating for torque in a motor according to an embodiment of the present invention. FIG. 3 is a side view illustrating a machine on which a device for compensating for torque in a motor according to an embodiment of the present invention is mounted. FIGS. 4 through 6 are plan views illustrating the operation of a device for compensating for torque in a motor according to an embodiment of the present invention. FIG. 7 is a plan view illustrating a device for compensating for torque in a motor according to another embodiment of the present invention, wherein the device includes a parallel elastic mechanism.

The present invention is directed to a device for compensating for torque in a motor, which reduces or offsets torque applied to a link (or a load) through the influence of gravity (hereinafter, referred to as “gravitational torque”) when the gravitational torque is applied to the link connected to a rotational shaft of the motor in a robot or automatic machine. More specifically, as illustrated in FIG. 3, the present invention is directed to a device capable of compensating for gravitational torque with a compressive or tensile force of at least one spring in order to reduce or offset the gravitational torque increased through the influence of gravity, wherein the device is directly coupled either to the rotational shaft of a driving motor 100 or to the shaft of a speed reducer 110, such as a harmonic drive or rotary vector (RV) reducer, which is attached to the rotational shaft of the driving motor 100.

The present invention generally comprises a stationary plate 10, a rotary plate 20, and an elastic mechanism 30 formed between the stationary plate 10 and the rotary plate 20.

As for the principle of the present invention, in the case of a low-speed motor, rather than a high-speed motor, such as a motor used for the arm or leg of a robot, torque attributable to gravity varies according to the angle of rotation of a load, and thus the motor requires additional force to counteract the torque.

Therefore, the maximum output of the motor used for such a purpose is determined in consideration of the magnitude of the maximum torque. Thus, the magnitude of the maximum torque is responsible for increasing the size of the motor.

As illustrated in FIG. 3, the present invention is a device that is mounted between the motor 100 and the load 40, and has functions to compensate for the torque caused by gravity. And the present invention includes two circular plates coupled to the output part of the motor 100, and an elastic mechanism disposed between the circular plates.

One of the circular plates is the stationary plate 10 that is fixed independently of the operation of the motor, and the other is the rotary plate 20 that is driven by the driving force of the motor.

As described above, the elastic mechanism 30 is disposed between the stationary plate 10 and the rotary plate 20. Thus, the elastic mechanism 30 is supported on the stationary plate 10, and provides the rotary plate 20 with elastic force in the direction opposite the rotational direction of the rotary plate 20.

As for the configuration of the present invention, the stationary plate 10 is a circular plate and is designed so that the rotational shaft of the motor 100 passes through the center thereof, and so that a body thereof is fixed to a part, such as a support, which is independent of the rotation of the rotational shaft of the motor.

The circular rotary plate 20 comes into close contact with the stationary plate 10, is coupled to the rotational shaft of the motor 100 (including a rotational shaft passing through the speed reducer), and is rotated by the rotational force of the motor 100.

The elastic mechanism 30 is a device that intermediates between the rotating state of the rotary plate 20 and the fixed state of the stationary plate 10, wherein the force for intermediation depends upon the elastic force thereof.

The relationship between the stationary plate 10 and the rotary plate 20 may be understood as one between the fixed end and the free end of an ordinary spring.

The elastic mechanism 30 formed between the rotary plate 20 and the stationary plate 10 comprises at least one slot 32, at least one spring 31, and at least one elastic blade 33. The slot 32 is a cavity that is recessed along the circumference of any one selected from an inner surface of the stationary plate 10 and an inner surface of the rotary plate 20, wherein the inner surfaces of the plates 10 and 20 are opposite to each other.

The slot 32 is preferably long and wide enough to allow the spring to be placed therein. The slot 32 has the shape of an arc, the center of which is the rotational shaft of the motor, so as to permit the rotational motion of the motor to be accurately transmitted.

The elastic blade 33 is formed on the inner surface of the rotary plate 20 or the stationary plate 10 that has no slot 32 (e.g. the inner surface of the rotary plate 20 if the stationary plate 10 has the slot).

The elastic blade 33 is a plate-like protruding structure inserted into the slot 32 when the rotary plate 20 comes into close contact with the stationary plate 10, and is preferably provided in the same number as the slot, such that elastic blades 33 are inserted into respective slots in one-to-one correspondence.

The spring 31 is inserted into the slot 32. The elastic blade 33 presses the spring 31 in contact with the elastic blade 33 when the rotary plate 20 is rotated. Thereby, the spring 31 acts against the inner wall of the slot, and thus provides an elastic force in the direction opposite the rotational direction.

These structures of the stationary plate 10 and the rotary plate 20 are illustrated in FIGS. 1 and 2.

In FIG. 1, the stationary plate having the slots 32 and springs 31 of the elastic mechanism is illustrated. In FIG. 2, the rotary plate having the elastic blades 33 of the elastic mechanism is illustrated. Of course, even if the stationary plate and the rotary plate are exchanged with each other, the technical content of the present invention can still be realized.

The direction of reaction of the springs depends on the coupled state of the springs 31. When one spring 31 per slot 32 is inserted between the slot 32 and the elastic blade 33 such that one end thereof serves as a fixed end and the other end thereof serves as a free end, the device for compensating for torque in a motor according to the present invention can compensate for gravitational torque caused by unidirectional rotation.

At this time, the fixed end may be fixed to either one of the slot 32 (specifically the wall of one end of the slot that extends a long distance in an arcuate shape) and the elastic blade 33. If the fixed end is fixed to the slot 32, the free end will be disposed toward the elastic blade 33. If the fixed end is fixed to the elastic blade 33, the free end will be disposed toward the slot 32.

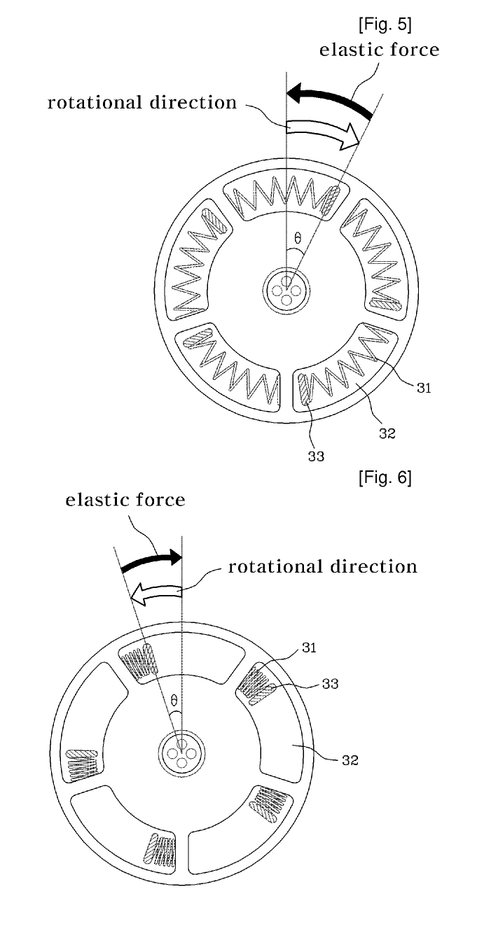

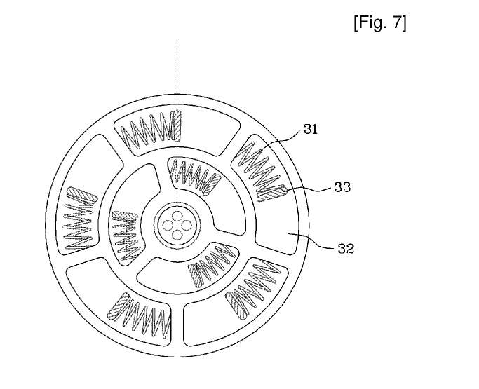

Meanwhile, as illustrated in FIG. 4, the slot 32 may be formed so as to be longer than the spring 31, and the opposite ends of the spring 31 may serve as the fixed end, and may thus be fixed both to the slot 32 and to the elastic blade 33. In this case, as illustrated in FIGS. 5 and 6, the elastic force (tensile force or compressive force) in either direction is generated centering on the point at which the elastic force is zero as illustrated in FIG. 4, so that the device for compensating for torque in a motor according to the present invention can compensate for gravitational torque caused by bidirectional rotation.

Such bidirectional compensation is possible in a manner such that two springs 31 per slot 32 are inserted between the slot 32 and the elastic blade 33 on opposite sides of the elastic blade 33 such that one end of each thereof serves as a fixed end and the other end of each thereof serves as a free end.

Now, as for the operation of the device for compensating for torque in a motor according to the present invention, the rotational shaft of the driving motor 100 or the speed reducer 110 coupled to the driving motor 100 passes through the center of the stationary plate 10 and is coupled to the rotary plate 20 to which a load (e.g. a robot arm, etc.) is coupled. The rotary plate 20 is rotated by rotation of the driving motor 100 or the speed reducer 110, and the load 40, such as the working object or the robot arm coupled to the rotary plate 20, is rotated and influenced by gravity. At this time, the springs 31 of the elastic mechanism, disposed between the stationary plate 10 and the rotary plate 20, are expanded or compressed in proportion to the amount of rotation of the load.

In other words, when the load 40, such as the working object or the robot arm, is rotated, the rotational angle θ is increased and thus the moment of the load is increased due to gravity. And when the moment due to gravity is increased, the gravitational torque applied to the driving motor is increased in proportion to the value of sin θ. As a result, each spring 31 of the elastic mechanism is expanded or compressed to generate a reaction torque. At this time, the generated reaction torque compensates for the amount of gravitational torque caused by the gravity and applied to the driving motor 100.

As described above, the device for compensating for torque in a motor according to the present invention is a device coupled between the output part of the driving motor 100 and the load 40. In the case in which the load 40 is controlled and driven at a low rotational speed, like the robot arm, the device for compensating for torque in a motor is a device that compensates for the gravitational torque applied to the load due to gravity.

In other words, the device for compensating for torque in a motor according to the prior art is designed so that, because the load 40, such as a robot arm having a given length, generates a torque caused by gravity according to the rotational angle thereof, the output of the driving motor 100 must be increased in order to overcome the generated torque. However, the inventive device for compensating for torque in a motor according to the present invention can compensate for the gravitational torque using the elastic force thereof, which is increased in proportion to the rotational angle, so that it can reduce the waste of output of the driving motor and the amount of the load weighting given to the driving motor, thus realizing a small sized lightweight device.

Meanwhile, the device for compensating for torque in a motor according to the present invention functions to compensate for the gravity applied to the load with the elastic force, so that the performance thereof is determined by the intensity of the elastic force.

Therefore, according to the present invention, as illustrated in FIG. 7, in order to apply the maximum elastic force to one surface, having a limited area, of the rotary plate or the stationary plate, at least one slot can be formed in the surface of the rotary plate or the stationary plate on one or more concentric circles in an arcuate shape. More specifically, the limited area of the surface of the rotary plate or the stationary plate is divided into a plurality of concentric circles in order to form the maximum number of slots in the limited area of the surface of the rotary plate or the stationary plate, and the slots are formed in an arcuate shape so as to be disposed on the concentric circles. As a result, the elastic mechanism has a plurality of parallel slots that form a plurality of concentric circles, and a plurality of elastic blades that are fitted into the concentric slots, so as to exert the maximum elastic recovery force in the limited area.

As apparent from the above description, the embodiment illustrated for the description of the present invention is merely one example of how the present invention can be embodied. Thus, it can be understood that a variety of combinations are possible in order to realize the subject matter of the present invention, as illustrated in the drawings.

Accordingly, those skilled in the art will appreciate that various modifications, additions and substitutions are possible, without departing from the scope and spirit of the invention as disclosed in the accompanying claims.

1. A device for compensating for torque in a motor, the device comprising:
a stationary plate that passes a rotational shaft of the motor through the center thereof, and that is fixed to a support independent of rotational motion of the motor;
a rotary plate that comes into close contact with the stationary plate, and that is rotatably coupled to the rotational shaft of the motor at the center thereof; and
an elastic mechanism that has at least one slot formed along a circumference of one selected from one surface of the stationary plate and one surface of the rotary plate, at least one elastic blade formed on the slot-free opposite surface and inserted into the slot, and at least one spring inserted into the slot and applying an elastic force in a circumferential direction in contact with the elastic blade,
wherein, when a load coupled to the rotary plate is subjected to gravitational torque depending on a rotational angle thereof due to gravity, the gravitational torque is compensated for by the circumferential elastic force generated from the elastic mechanism.

2. The device as set forth in claim 1, wherein the elastic mechanism has one spring per slot, and the spring is inserted between an inner wall of one end of the slot and the elastic blade such that one end thereof serves as a fixed end and the other end thereof serves as a free end, so that the device compensates for the gravitational torque caused by unidirectional rotation.

3. The device as set forth in claim 1, wherein the spring is inserted between an inner wall of one end of the slot and the elastic blade such that opposite ends thereof serve as fixed ends, so that the device compensates for the gravitational torque caused by bidirectional rotation.

4. The device as set forth in claim 1, wherein the elastic mechanism has two springs per slot, and the two springs are inserted between the slot and the elastic blade on opposite sides of the elastic blade such that one end of each thereof serves as a fixed end and the other end of each thereof serves as a free end, so that the device compensates for the gravitational torque caused by bidirectional rotation.

5. The device as set forth in claim 1, wherein the elastic mechanism is a parallel elastic mechanism having a concentric arcuate shape in which at least one slot can be formed in an arcuate shape in any one selected from the surface of the rotary plate and the surface of the stationary plate on each of at least two concentric circles having different diameters, and at least one elastic blade is formed on the other opposed surface and fitted into the slot.
